(19) United States
(12) Patent Application Publication
(10) Pub. No.: US 2021/0287616 A1
(43) Pub. Date: Sep. 16, 2021

(54) DISPLAY DEVICE

(71) Applicant: SHARP KABUSHIKI KAISHA, Sakai City (JP)

(72) Inventors: YUICHI KAWAHIRA, Sakai City (JP); AKIRA HIRAI, Sakai City (JP); AKIRA SAKAI, Sakai City (JP); KIYOSHI MINOURA, Sakai City (JP)

(21) Appl. No.: 17/199,240

(22) Filed: Mar. 11, 2021

(30) Foreign Application Priority Data
Mar. 13, 2020 (JP) 2020-044112

(51) Int. Cl. G09G 3/34; G09G 5/10; G02F 1/1335; G02F 1/1362

(52) U.S. Cl. CPC G09G 3/3406; G09G 5/10; G09G 2320/0626; G02F 1/133553; G02F 1/136286; G02F 1/133528

(57) ABSTRACT

A liquid crystal panel for display that displays an image by controlling transmission of the light emitted from the illumination device, in which the illumination device includes a light source, and a liquid crystal panel for dimming which is disposed closer to the liquid crystal panel for display than the light source, and the liquid crystal, panel for dimming includes a signal line, and a reflection layer that is disposed closer to the light source than the signal line in at least a part of a region overlapping the signal line in plan view, and has a higher average luminous reflectance in a visible wavelength region of 400 nm or more and 700 nm or less than the signal line.

### BACKGROUND

### 1. Field

The present disclosure relates to a display device.

### 2. Description of the Related Art

For example, Japanese Unexamined Patent Application Publication No. 2010-134269 describes a liquid crystal display device as follows. In the liquid crystal display device described in Japanese Unexamined Patent Application Publication No. 2010-134269, an optical shutter that has a twisted nematic (TN) liquid crystal panel and reflective polarizing sheets provided on both sides of the TN liquid crystal panel is disposed between a liquid crystal display panel and a backlight. Japanese Unexamined Patent Application Publication No. 2010-134269 describes that the TN liquid crystal panel includes liquid crystal substances, and a plurality of X electrodes and a plurality of Y electrodes which are provided so as to interpose liquid crystal substances and extend in a direction orthogonal to each other.

There is a demand for the display device to improve the efficiency of extracting light emitted from a light source.

It is desirable to provide a display device that has a high efficiency of extracting light emitted from a light source.

### SUMMARY

According to an aspect of the present disclosure, there is provided a display device that includes an illumination device and a liquid crystal panel for display. The illumination device emits light. The liquid crystal panel for display displays an image by controlling transmission of the light emitted from the illumination device. The illumination device includes a light source, and a liquid crystal panel for dimming. The liquid crystal panel for dimming is disposed closer to the liquid crystal panel for display than the light source. The liquid crystal panel for dimming includes a signal line, and a reflection layer. The reflection layer is disposed closer to the light source than the signal line in at least a part of a region overlapping the signal line in plan view. The reflection layer has a higher average luminous reflectance in a visible wavelength region of 400 nm or more and 700 nm or less than the signal line.

According to another aspect of the present disclosure, there is provided a display device that includes an illumination device and a liquid crystal panel for display. The illumination device emits light. The liquid crystal panel for display displays an image by controlling transmission of the light emitted from the illumination device. The illumination device includes a light source, and a liquid crystal panel for dimming. The liquid crystal panel for dimming is disposed closer to the liquid crystal panel for display than the light source. The liquid crystal panel for dimming includes a signal line. The signal line is configured such that an average luminous reflectance of a surface of the signal line on a side of the light source in a visible wavelength region of 400 nm or more and 700 nm or less is 70% or more.

### BRIEF DESCRIPTION OF THE DRAWINGS

FIG. 1 is an enlarged schematic plan view of a part of a display device according to a first embodiment;

FIG. 2 is a schematic sectional view taken along a line II-II of FIG. 1;

FIG. 3 is an enlarged schematic sectional view of a part of a display device according to a second embodiment;

FIG. 4 is an enlarged schematic sectional view of a part of a display device according to a third embodiment;

FIG. 5 is an enlarged schematic sectional view of a part of a display device according to a fourth embodiment;

FIG. 6 is an enlarged schematic sectional view of a part of a display device according to a fifth embodiment; and

FIG. 7 is an enlarged schematic sectional view of a part of a display device according to a sixth embodiment.

### DESCRIPTION OF THE EMBODIMENTS

Hereinafter, an example of preferable embodiments of the present disclosure will be described. However, the embodiments described below are merely examples. The present disclosure is not limited to the embodiments described below.

### First Embodiment

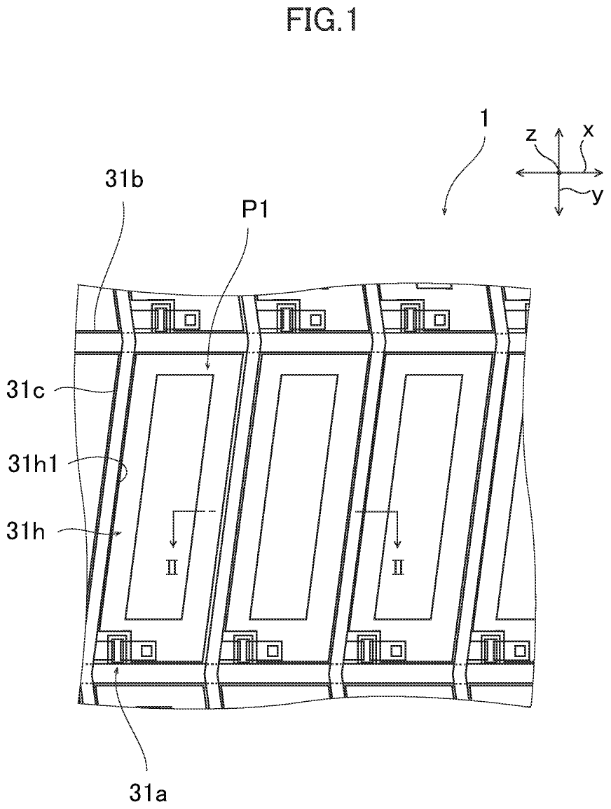

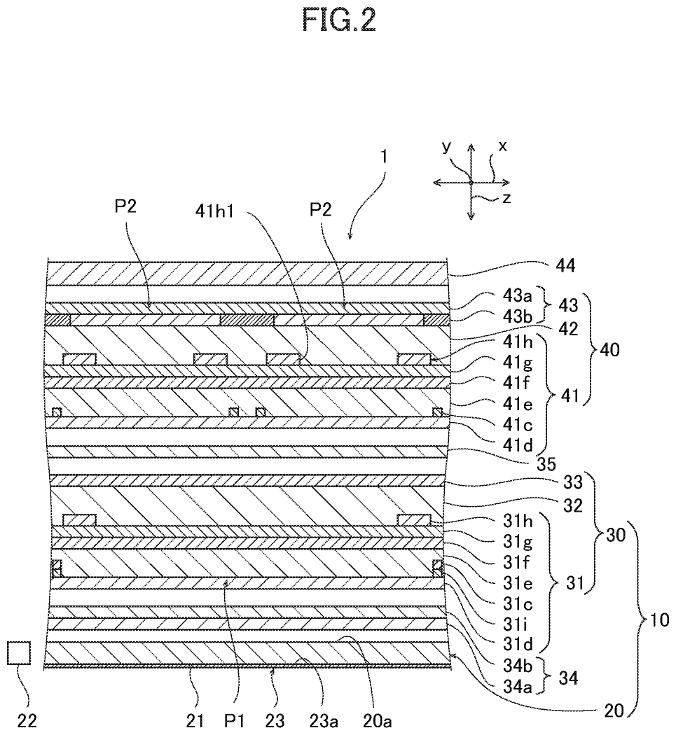

FIG. 1 is an enlarged schematic plan view of a part of a display device 1 according to a first embodiment. FIG. 2 is a schematic sectional view taken along a line II-II of FIG. 1. In FIG. 1, for convenience of drawing, a part of the hidden lines is drawn by a solid line.

As illustrated in FIG. 2, the display device 1 includes an illumination device 10 and a liquid crystal panel 40 for display.

### Illumination Device 10

The illumination device 10 is a device that emits light to the liquid crystal panel 40 for display. The liquid crystal panel 40 for display is a panel that displays an image by transmitting the light emitted from the illumination device 10.

Here, in the present disclosure, it is assumed that the “image” includes characters. The “image” includes a still image and a moving image.

The illumination device 10 includes a light source 20, and a liquid crystal panel 30 for dimming.

### Light Source 20

The light source 20 emits light to the liquid crystal panel 30 for dimming. For example, the light source 20 may be an edge light type light source or a direct type light source. The edge light type light source may include, for example, a light guide place that has a light emission surface on one principal surface, a light emitting element that emits light to a side surface of the light guide plate, and an optical film, such as a scatter plate that is disposed on the light emission surface. The direct type light source may include a plurality of light emitting elements that are disposed in a matrix, and an optical film, such as a scatter plate that is disposed between the plurality of light emitting elements and the liquid crystal panel for dimming.

Hereinafter, in the present embodiment, an example will be described in which the light source 20 is an edge light type light source.

The light source 20 includes a light guide 21, at least one light emitting element 22, and a reflection layer 23.

The light guide 21 is formed in a plate shape. One principal surface of the light guide 21 configures a light emission surface 20a of the light source 20.

At least one light emitting element 22 is disposed such that, for example, the light emitted from the light emitting element 22 is incident on a side surface of the light guide 21. The light emitting element 22 can be configured by, for example, a light emitting diode (LSD).

The reflection layer 23 is formed on a principal surface of the light guide 21 opposite to the principal surface on which the light emission surface 20a is formed. The reflection layer 23 includes a reflective surface 23a. The reflective surface 23a reflects light incident from the light emitting element 22 or the like toward the liquid crystal panel 30 for dimming. The reflection layer 23 can be configured by, for example, an aluminum layer, a white coating film layer, or the like.

### Liquid Crystal Panel 30 for Dimming

The liquid crystal panel 30 for dimming is disposed closer to the liquid crystal panel 40 for display than the light source 20.

The liquid crystal panel 30 for dimming is disposed on or above the light emission surface 20a of the light source 20.

The liquid crystal panel 30 for dimming is an element that controls the transmittance of the light emitted from the light source 20 for each area. For example, the liquid crystal panel 30 for dimming makes the transmittance of the light emitted from the light source 20 in at least one area of the plurality of areas different from the transmittance of the light emitted from the light source 20 in at least the other area of the areas. By providing the liquid crystal panel 30 for dimming, it is possible to control the brightness of the light emitted from the illumination device 10 for each area. As a result, for example, it is possible to reduce the power consumption of the display device 1 and to increase the contrast.

A drive system of the liquid crystal panel 30 for dimming is not particularly limited. Hereinafter, an example will be described in which the liquid crystal panel 30 for dimming is configured by a liquid crystal panel of a lateral electric field drive system (lateral electric field mode), such as an in-plane switching (IPS) mode or a fringe-field switching (FFS) mode.

As illustrated in FIG. 1, the liquid crystal panel 30 for dimming includes a plurality of pixels P1. The plurality of pixels P1 are disposed in a matrix along an x-axis direction and a y-axis direction orthogonal to the x-axis direction.

As illustrated in FIG. 2, the liquid crystal panel 30 for dimming includes an active matrix substrate 31, a liquid crystal layer 32, and a counter substrate 33.

The active matrix substrate 31 includes a plurality of switching elements 31a illustrated in FIG. 1. At least one switching element 31a is disposed in each of the plurality of pixels P1. Specifically, in the present embodiment, one switching element 31a is disposed in each pixel P1. However, the present disclosure is not limited to this configuration. The plurality of switching elements may be disposed in each of the plurality of pixels.

The configuration of the switching element 31a is not limited particularly. In the present embodiment, the switching element 31a is configured by a thin film transistor (TFT). Therefore, the active matrix substrate 31 may be referred to as, for example, a TFT substrate.

The active matrix substrate 31 further includes a plurality of first signal lines 31b and a plurality of second signal lines 31c. The first signal line 31b and the second signal line 31c are disposed so as to intersect each other. Each of the plurality of switching elements 31a is connected to each of the first signal lines 31b and the second signal lines 31c. In the present embodiment, the first signal line 31b configures a gate line, and the second signal line 31c configures a source line.

Hereinafter, the configuration of the active matrix substrate 31 will be more specifically described with reference to FIGS. 1 and 2.

As illustrated in FIG. 2, the active matrix substrate 31 includes an insulating plate 31d. The insulating plate 31d is a substrate in which at least one principal surface has an insulation property. For example, the insulating plate 31d can be made of a glass plate or the like. The plurality of switching elements 31a, the plurality of first signal lines 31b, and the plurality of second signal lines 31c which are illustrated in FIG. 1 are formed on the insulating plate 31d.

The plurality of first signal lines 31b each extend along the x-axis direction. The plurality of first signal lines 31b are disposed at intervals along the y-axis direction. The first signal line 31b configures the gate line.

The plurality of second signal lines 31c each extend along the y-axis direction. The plurality of second signal lines 31c are disposed at intervals along the x-axis direction. The second signal line 31c configures the source line. An insulating film which is not illustrated is disposed between the plurality of second signal lines 31c and the plurality of first signal lines 31b. The plurality of second signal lines 31c and the plurality of first signal lines 31b are electrically insulated from each other by the insulating film.

The switching element 31a is disposed in the vicinity of each intersection between the plurality of first signal lines 31b and the plurality of second signal lines 31c. The switching element 31a is connected electrically to each of the first signal lines 31b and the second signal lines 31c. Specifically, a gate electrode of the switching element 31a is connected electrically to the first signal line 31b as the gate line. A source electrode of the switching element 31a is connected electrically to the second signal line 31c as the source line.

The plurality of first signal lines 31b and the plurality of second signal lines 31c are provided such that the plurality of pixels P1 are obtained by partitioning by the plurality of first signal lines 31b and the plurality of second signal lines 31c.

The plurality of first signal lines 31b and the plurality of second signal lines 31c each include a conductive layer.

The conductive layer may be configured by, for example, a layer made of any of at least one metal selected from the group consisting of Ti, Cu, Mo, W, and Ta, an oxide including at least one metal of Ti, Cu, Mo, W, and Ta, and a nitride including at least one metal of Ti, Cu, Mo, W, and Ta. Also, the conductive layer may be configured by a laminate of a plurality of the conductive layers.

The active matrix substrate 31 further includes an insulating film 31e, a common electrode 31f, an insulating film 31g, and a plurality of pixel electrodes 31h, as illustrated in FIG. 2.

On the insulating plate 31d, the insulating film 31e is formed so as to cover the plurality of first signal lines 31b, the plurality of second signal lines 31c, and the plurality of switching elements 31a. For example, the insulating film 31e may be made of silicon oxide, silicon nitride, or the like.

The common electrode 31f is formed on the insulating film 31e. The common electrode 31f is provided so as to extend over the plurality of pixels P1. For example, the common electrode 31f can be made of transparent conductive oxide (TCO), such as indium tin oxide (ITO), indium zinc oxide (IZO), aluminum zinc oxide (ZnO:Al (AZO)), and IGZO.

The insulating film 31g is formed on the common electrode 31f. The insulating film 31g covers the common electrode 31f. For example, the insulating film 31g may be made of silicon oxide, silicon nitride, or the like.

The plurality of pixel electrodes 31h are formed on the insulating film 31g. The plurality of pixel electrodes 31h and the common electrode 31f are insulated from each other by the insulating film 31g. The plurality of pixel electrodes 31h are disposed in a matrix along the x-axis direction and the y-axis direction, as illustrated in FIG. 1. Each of the plurality of pixels P1 is provided with the pixel electrode 31h. The pixel electrode 31h is connected electrically to a drain electrode of the switching element 31a. In the pixel electrode 31h, an opening 31h1 is formed. The pixel electrode 31h and the common electrode 31f are provided such that a fringe electric field is formed between the electrodes thereof. For example, the plurality of pixel electrodes 31h can be made of transparent conductive oxide (TCO), such as indium tin oxide (ITO), indium zinc oxide (IZO), aluminum zinc oxide (ZnO:Al (AZO)), and IGZO.

An alignment film which is not illustrated is formed on the active matrix substrate 31.

For example, the alignment film can be made of polyimide or the like.

As illustrated in FIG. 2, the principal surface of the active matrix substrate 31 on the side in which the pixel electrode 31h is formed faces the counter substrate 33 at an interval. An alignment film which is not illustrated is formed on the surface of the counter substrate 33 on the active matrix substrate 31 side. For example, the alignment film can be made of polyimide or the like.

The liquid crystal layer 32 is disposed between the active matrix substrate 31 and the counter substrate 33. The liquid crystal layer 32 includes a plurality of liquid crystal molecules. For example, the liquid crystal molecule may be a nematic liquid crystal molecule that has the electro-optical characteristic. The liquid crystal molecule may have a positive anisotropy of dielectric constant or may have a negative anisotropy of dielectric constant.

### First Polarizing Plate 34 and Second Polarizing Plate 35

A first polarizing plate 34 and a second polarizing plate 35 are disposed on both sides of the liquid crystal panel 30 for dimming. For example, it is preferable that the first polarizing plate 34 and the second polarizing plate 35 be disposed in a crossed Nicol state such that absorption axes thereof are orthogonal to each other.

The first polarizing plate 34 is disposed between the liquid crystal panel 30 for dimming and the light source 20. The first polarizing plate 34 is disposed closer to the light source 20 than the liquid crystal panel 30 for dimming. The first polarizing plate 34 configures the first polarizing layer. In the present embodiment, the first polarizing layer is configured by a plate independent of the liquid crystal panel for dimming. However, the present disclosure is not limited to this configuration. The first polarizing layer may be, for example, a layer formed on the liquid crystal panel for dimming.

The first polarizing plate 34 includes a reflective polarizing plate 34a and an absorption type polarizing plate 34b. The reflective polarizing plate 34a is disposed closer to the light source 20 than the absorption type polarizing plate 34b. The absorption type polarizing plate 34b is disposed between the reflective polarizing plate 34a and the liquid crystal panel 30 for dimming.

Here, the “reflective polarizing plate” refers to a polarizing plate in which the transmittance of polarized light that vibrates along the transmission axis is higher than the transmittance of polarized light that vibrates along the polarization axis orthogonal to the transmission axis, by selectively reflecting polarized light that has a polarization axis orthogonal to the polarization axis (transmission axis) of transmitted polarized light.

The “absorption type polarizing plate” refers to polarizing plate in which the light absorption rate of polarized light that vibrates along the transmission axis is higher than the light absorption rate of polarized light that vibrates in the direction orthogonal to the transmission axis, and thus the transmittance of polarized light that vibrates along the transmission axis is higher than the transmittance of polarized light that vibrates along the polarization axis orthogonal to the transmission axis.

Specifically, the absorption type polarizing plate can be made of, for example, a polyvinyl alcohol (PVA) film that contains an anisotropic material, such as a dichroic iodine complex or dye in an alignment state.

The second polarizing plate 35 is disposed between the liquid crystal panel 30 for dimming and the liquid crystal panel 40 for display. The second polarizing plate 35 is disposed closer to the liquid crystal panel 40 for display than the liquid crystal panel 30 for dimming. The second polarizing plate 35 configures the second polarizing layer. In the present embodiment, the second polarizing layer is configured by a plate independent of the liquid crystal panel for dimming or the liquid crystal panel for display. However, the present disclosure is not limited to this configuration. The second polarizing layer may be, for example, a layer formed on at least one of the liquid crystal panel for dimming and the liquid crystal panel for display.

In the present embodiment, the second polarizing plate 35 is configured by the absorption type polarizing plate. It is preferable that an average transmittance of the first polarizing plate 34 in a visible wavelength region of polarized light that vibrates in a direction (first direction) parallel to the transmission axis of the first polarizing plate 34 be higher than an average transmittance of the second polarizing plate 35 in a visible wavelength region of polarized light that vibrates in a direction (second direction) parallel to the transmission axis of the second polarizing plate 35.

As described above, in the present embodiment, the first polarizing plate 34 and the second polarizing plate 35 are disposed in a crossed Nicol state. Therefore, the first direction parallel to the transmission axis of the first polarizing plate 34 and the second direction parallel to the transmission axis of the second polarizing plate 35 are orthogonal to each other.

### Liquid Crystal Panel 40 for Display

The liquid crystal panel 40 for display is disposed on the light emitting side of the illumination device 10. Specifically, the liquid crystal panel 40 for display displays an image by controlling transmission of the light emitted from the illumination device 10 for each area.

A drive system of the liquid crystal panel 40 for display is not particularly limited. Hereinafter, an example will be described in which the liquid crystal panel 40 for display is configured by the liquid crystal panel of a lateral electric field drive system (lateral electric field mode), such as an IPS mode or an FFS mode.

The liquid crystal panel 40 for display also includes a plurality of pixels P2 (see FIG. 2) as in the liquid crystal panel 30 for dimming. In the liquid crystal panel 40 for display, the plurality of pixels P2 are disposed in a matrix along the x-axis direction and the y-axis direction. The pixel P2 of the liquid crystal panel 40 for display is smaller than the pixel P1 of the liquid crystal panel 30 for dimming. Specifically, the plurality of pixels P2 (for example, about 2 to 4 pixels P2) are disposed on a region in which each of the plurality of pixels P1 is provided. Therefore, in the display device 1, the liquid crystal panel 30 for dimming is configured such that the brightness can be controlled for each of the plurality of, for example, about 2 to 4, pixels P2.

The liquid crystal panel 40 for display includes an active matrix substrate 41, a liquid crystal layer 42, and a counter substrate 43.

The active matrix substrate 41 includes a plurality of switching elements which are not illustrated. At least one switching element is disposed in each of the plurality of pixels P2. Specifically, in the present embodiment, one switching element is disposed in each pixel P2. However, the present disclosure is not limited to this configuration. The plurality of switching elements may be disposed in each of the plurality of pixels.

The configuration of the switching element is not limited particularly. In the present embodiment, the switching element is configured by a TFT. Therefore, the active matrix substrate 41 may be referred to as, for example, a TFT substrate.

The active matrix substrate 41 further includes a plurality of first signal lines which are not illustrated and a plurality of second signal lines 41c. The first signal line and the second signal line 41c are disposed so as to intersect each other. Each of the plurality of switching elements is connected to each of the first signal lines and the second signal lines 41c. In the present embodiment, the first signal line configures a gate line, and the second signal line 41c configures a source line.

More specifically, the active matrix substrate 41 includes an insulating plate 41d. The insulating plate 41d is a substrate in which at least one principal surface has an insulation property. For example, the insulating plate 41a can be made of a glass plate or the like. The plurality of switching elements, the plurality of first signal lines, and the plurality of second signal lines 41c are formed on the insulating plate 41d.

The plurality of first signal lines each extend along the x-axis direction. The plurality of first signal lines are disposed at intervals along the y-axis direction. The first signal line configures the gate line.

The plurality of second signal lines 41c each extend along the y-axis direction. The plurality of second signal lines 41c are disposed at intervals along the x-axis direction. The second signal line 41c configures the source line. An insulating film which is not illustrated is disposed between the plurality of second signal lines 41c and the plurality of first signal lines. The plurality of second signal lines 41c and the plurality of first signal lines are electrically insulated from each other by the insulating film.

The switching element is disposed in the vicinity of each intersection between the plurality of first signal lines and the plurality of second signal lines 41c. The switching element is connected electrically to each of the first signal lines and the second signal lines 41c. Specifically, a gate electrode of the switching element is connected electrically to the first signal line as the gate line. A source electrode of the switching element is connected electrically to the second signal line 41c as the source line.

The plurality of first signal lines and the plurality of second signal lines 41c are provided such that the plurality of pixels P2 are obtained by partitioning by the plurality of first signal lines and the plurality of second signal lines 41c.

The plurality of first signal lines and the plurality of second signal lines 41c each include a conductive layer.

For example, the conductive layer may be configured by a layer made of any of at least one metal selected from the group consisting of Ti, Cu, Mo, W, and Ta, an oxide including at least one metal of Ti, Cu, Mo, W, and Ta, and a nitride including at least one metal of Ti, Cu, Mo, W, and Ta. Also, the conductive layer may be configured by a laminate of a plurality of the conductive layers.

The active matrix substrate 41 further has an insulating film 41e, a common electrode 41f, an insulating film 41g, and a plurality of pixel electrodes 41h.

On the insulating plate 41d, the insulating film 41e is formed so as to cover the plurality of first signal lines, the plurality of second signal lines 41c, and the plurality of switching elements. For example, the insulating film 41e may be made of silicon oxide, silicon nitride, or the like.

The common electrode 41f is formed on the insulating film 41e. The common electrode 41f is provided so as to extend over the plurality of pixels P2. For example, the common electrode 41f can be made of transparent conductive oxide (TCO), such as indium tin oxide (ITO), indium zinc oxide (IZO), aluminum zinc oxide (ZnO:Al (AZO)), and IGZO.

The insulating film 41g is formed on the common electrode 41f. The insulating film 41g covers the common electrode 41f. For example, the insulating film 41g may be made of silicon oxide, silicon nitride, or the like.

The plurality of pixel electrodes 41h are formed on the insulating film 41g. The plurality of pixel electrodes 41h and the common electrode 41f are insulated from each other by the insulating film 41g. The plurality of pixel electrodes 41h are disposed in a matrix along the x-axis direction and the y-axis direction. Each of the plurality of pixels P2 is provided with the pixel electrode 41h. The pixel electrode 41h is connected electrically to a drain electrode of the switching element. In the pixel electrode 41h, an opening 41h1 is formed. The pixel electrode 41h and the common electrode 41f are provided such that a fringe electric field is formed between the electrodes thereof. For example, the plurality of pixel electrodes 41h can foe made of transparent conductive oxide (TCO), such as indium tin oxide (ITO), indium zinc oxide (IZO), aluminum zinc oxide (ZnO:Al (AZO)), and IGZO.

An alignment film which is not illustrated is formed on the active matrix substrate 41.

For example, the alignment film can be made of polyimide or the like.

The principal surface of the active matrix substrate 41 on the side in which the pixel electrode 41h is formed faces the counter substrate 43 at an interval. The counter substrate 43 includes an insulating plate 43a and a color filter substrate 43b. The insulating plate 43a has a configuration substantially the same as the insulating plate 33. Therefore, the description regarding the insulating plate 33 is incorporated into the insulating plate 43a.

The color filter substrate 43b is disposed on the surface of the insulating plate 43a on the liquid crystal layer 42 side.

An alignment film which is not illustrated is formed on the surface of the counter substrate 43 on the active matrix substrate 41 side. For example, the alignment film can be made of polyimide or the like.

The liquid crystal layer 42 is disposed between the active matrix substrate 41 and the counter substrate 43. The liquid crystal layer 42 includes a plurality of liquid crystal molecules. For example, the liquid crystal molecule may be a nematic liquid crystal molecule that has the electro-optical characteristic. The liquid crystal molecule may have a positive anisotropy of dielectric constant or may have a negative anisotropy of dielectric constant.

### Third Polarizing Plate 44

The second polarizing plate 35 and a third polarizing plate 44 are disposed on both sides of the liquid crystal panel 40 for display. The second polarizing plate 35 is disposed closer to the light source 20 than the liquid crystal panel 40 for display. The third polarizing plate 44 is disposed on the side of the liquid crystal panel 40 for display opposite to the light source 20. For example, it is preferable that the second polarizing plate 35 and the third polarizing plate 44 be disposed in a crossed Nicol state such that absorption axes thereof are orthogonal to each other.

The third polarizing plate 44 is configured by the absorption type polarizing plate. The third polarizing plate 44 configures the third polarizing layer. In the present embodiment, the third polarizing layer is configured by a plate independent of the liquid crystal panel for display. However, the present disclosure is not limited to this configuration. The third polarizing layer may be, for example, a layer formed on the liquid crystal panel for display.

It is preferable that the average transmittance of the first polarizing layer configured by the first polarizing plate 34 in the visible wavelength region of polarized light that vibrates in a direction (first direction) parallel to the transmission axis of the first polarizing layer be higher than an average transmittance of the third polarizing layer configured by the third polarizing plate 44 in a visible wavelength region of polarized light that vibrates in a direction (third direction) parallel to the transmission axis of the third polarizing layer. The average transmittance of the second polarizing layer configured by the second polarizing plate 35 in the visible wavelength region of polarized light that vibrates in a direction (second direction) parallel to the transmission axis of the second polarizing layer may be the same as the average transmittance of the third polarizing layer in the visible wavelength region of polarized light that vibrates in the third direction parallel to the transmission axis of the third polarizing layer, or may be higher than the average transmittance of the third polarizing layer in the visible wavelength region of polarized light that vibrates in the third direction parallel to the transmission axis of the third polarizing layer.

In a case in which the light emitted from the light source 20 is incident on the signal lines such as the first signal line 31b and the second signal line 31c of the liquid crystal panel 30 for dimming, a part of the incident light is reflected toward the light source 20 side by the signal line. However, for example, in a case in which the conductive layer included in the signal line is made of any of at least one metal selected from the group consisting of Ti, Cu, Mo, W, and Ta, an oxide including at least one metal of Ti, Cu, Mo, W, and Ta, and a nitride including at least one metal of Ti, Cu, Mo, W, and Ta, the light reflectance due to the conductive layer is low, and a part of light incident on the conductive layer is absorbed. In particular, as in the present embodiment, in a case in which the conductive layer made of any of at least one metal selected from the group consisting of Ti, Cu, Mo, W, and Ta, an oxide including at least one metal of Ti, Cu, Mo, W, and Ta, and a nitride including at least one metal of Ti, Cu, Mo, W, and Ta configures the surface of the signal line on the light source 20 side, the light reflectance is likely to be low due to the conductive layer. Therefore, the efficiency of extracting the light emitted from light source 20 is likely to be low, and it is difficult to increase the brightness of the display device.

Here, in the display device 1, a reflection layer 31i is provided closer to the light source 20 than the signal lines that include the first signal line 31b and the second signal line 31c. The reflection layer 31i is disposed closer to the light source 20 than the signal lines that include the first signal line 31b and the second signal line 31c. The reflection layer 31i is disposed on at least a part of a region overlapping the signal lines that include the first signal line 31b and the second signal line 31c. In the present embodiment, specifically, the reflection layer 31i is provided in the entire region overlapping the signal lines that include the first signal line 31b and the second signal line 31c. More specifically, in the present embodiment, the reflection layer 31i is disposed between the entire signal lines that include the first signal line 31b and the second signal line 31c, and the insulating plate 31d. The reflection layer 31i has a higher average luminous reflectance in a visible wavelength region of 400 nm or more and 700 nm or less than the signal lines that include the first signal line 31b and the second signal line 31c. As described above, the reflection layer 31i is provided in the display device 1, and thus absorption of light incident on the signal line side from the light source 20 due to the signal line is suppressed, and the reflectance to the light source 20 side of light incident on the signal line side from the light; source 20 is increased. Accordingly, the utilization efficiency of the light emitted from the light source 20 is improved. Therefore, the brightness of the display device 1 is increased. In other words, the display device 1 has high brightness.

From the viewpoint of increasing the brightness of the display device 1, the average luminous reflectance of the reflection layer 31i in the visible wavelength region is preferably higher than the average luminous reflectance of the signal line such as the first signal line 31b and the second signal line 31c in the visible wavelength region by 70% or more, and more preferably by 85% or more.

The configuration of the reflection layer 31i is not particularly limited as long as the average luminous reflectance in the visible wavelength region thereof is higher than that of the signal line. For example, the reflection layer 31i may include a layer made of at least one metal of Al, Ag, and Pt. For example, the reflection layer 31i may include a layer made of at least one of Al, Al alloy, Ag, Ag alloy, Pt, and Pt alloy. The reflection layer 31i may be configured by a layer made of at least one of Al, Al alloy, Ag, Ag alloy, Pt, and Pt alloy, or a laminate of a plurality of layers made of at least one of Al, Al alloy, Ag, Ag alloy, Pt, and Pt alloy. The layer made of at least one metal of Al, Ag, and Pt has a higher average luminous reflectance in the visible wavelength region than the signal line made of, for example, any of at least one metal selected from the group consisting of Ti, Cu, Mo, W, and Ta, an oxide including at least one metal of Ti, Cu, Mo, W, and Ta, and a nitride including at least one metal of Ti, Cu, Mo, W, and Ta. Therefore, by providing such a reflection layer 31i, the reflectance to the light source 20 side of the light emitted from the light source 20 can be suitably improved.

Also, the reflection layer 31i may include a dielectric multilayer film. Even in a case in which the reflection layer 31i includes a dielectric multilayer film, the reflectance to the light source 20 side of the light emitted from the light source 20 can be suitably improved. Specifically, the reflection layer 31i may be configured by the dielectric multilayer film, or may be configured by a laminate of at least one layer made of at least one of Al, A1 alloy, Ag, Ag alloy, Pt, and Pt alloy and the dielectric multilayer film. In this case, it is preferable that the dielectric multilayer film be positioned closer to the light source 20 than at least one layer made of at least one of Al, Al alloy, Ag, Ag alloy. Pt, and Pt alloy.

The dielectric multilayer film is a multilayer film in which a low-refractive-index dielectric film that has a relatively low refractive index and a high-refractive-index dielectric film that has a relatively high refractive index are alternately laminated. The low-refractive-index dielectric film can be made of. for example, silicon oxide, silicon fluoride, aluminum oxide, aluminum fluoride, or the like. The high-refractive-index dielectric film can be made of, for example, titanium oxide, niobium oxide, tungsten oxide, lanthanum oxide, yttrium oxide, aluminum oxide, or the like. The total number of the low-refractive-index dielectric film and the high-refractive-index dielectric film forming a dielectric multilayer film is not particularly limited, however, for example, it may be about 2 to 100 layers. Further, in the dielectric multilayer film, the dielectric film that has a higher refractive index than the low-refractive-index dielectric film and a lower refractive index than the high-refractive-index dielectric film may be further provided between the low-refractive-index dielectric film and the high-refractive-index dielectric film.

In the present disclosure, the position of the reflection layer in a laminating direction is not particularly limited as long as the position is closer to the light source than the signal line. The reflection layer may be disposed on the side of the liquid crystal layer of the liquid crystal panel for dimming opposite to the light source. In this case, however, the light incident on the reflection layer from the light source passes through the liquid crystal layer, and the light reflected by the reflection layer and directed toward the light source also passes through the liquid crystal layer. As a result, the incident light on and the reflected light from the reflection layer are likely to be absorbed by the liquid crystal layer. Therefore, like the display device 1, it is preferable that the reflection layer 311 be positioned closer to the light source 20 than the liquid crystal layer 32 of the liquid crystal panel 30 for dimming. In this case, it is possible to suppress absorption by the liquid crystal layer 32 of the light incident on the reflection layer 31i from the light source 20 and the light reflected by the reflection layer 31i toward the light source 20 side. As a result, the efficiency of extracting the light emitted from the light source 20 from the display device 1 can be further increased.

From the viewpoint of increasing the efficiency of extracting the light emitted from the light source 20 from the display device 1, it is preferable that the average transmittance of the first polarizing layer configured by the first polarizing plate 34 in the visible wavelength region of light that vibrates in the first direction parallel to the transmission axis of the first polarizing layer be higher than the average transmittance of the second polarizing layer configured by the second polarizing plate 35 in the visible wavelength region of light that vibrates in the second direction parallel to the transmission axis of the second polarizing layer. By increasing the average transmittance of the first polarizing layer configured by the first polarizing plate 34 positioned closer to the light source 20 than the reflection layer 31i in the visible wavelength region, it is possible to suppress absorption by the first polarizing layer of light incident on the reflection layer 31i from the light source 20 and light reflected toward the light source 20 side by the reflection layer 31i. As a result, it is possible to further increase the efficiency of extracting the light emitted from the light source 20 from the display device 1.

From the viewpoint of increasing the efficiency of extracting the light emitted from the light source 20 from the display device 1, the average transmittance of the first polarizing layer configured by the first polarizing plate 34 in the visible wavelength region of light that vibrates in the first direction is more preferably higher than the average transmittance of the second polarizing layer configured by the second polarizing plate 35 in the visible wavelength region of light that vibrates in the second direction by 2.9% or more, and still more preferably by 5.0% or more. However, in a case in which the average transmittance of the first polarizing layer configured by the first polarizing plate 34 in the visible wavelength region of the light that vibrates in the first direction is too high, the contrast of the display device 1 may decrease. Accordingly, the average transmittance of the first polarizing layer configured by the first polarizing plate 34 in the visible wavelength region of light that vibrates in the first direction is preferably 1.14 times or less of the average transmittance of the second polarizing layer configured by the second polarizing plate 35 in the visible wavelength region of light that vibrates in the second direction, and more preferably 1.08 times or less.

From the same viewpoint, the average transmittance of the first polarizing layer configured by the first polarizing plate 34 in the visible wavelength region of polarized light that vibrates in the first direction is preferably higher than the average transmittance of the third polarizing layer configured by the third polarizing plate 44 in the visible wavelength region of polarized light that vibrates in the third direction parallel to the transmission axis of the third polarizing layer, more preferably higher than the average transmittance of the third polarizing layer configured by the third polarizing plate 44 in the visible wavelength region of polarized light that vibrates in the third direction by 2.9% or more, and still more preferably by 5.0% or more. The average transmittance of the first polarizing layer configured by the first polarizing plate 34 in the visible wavelength region of polarized light that vibrates in the first direction is preferably 1.14 times or less of the average transmittance of the third polarizing layer configured by the third polarizing plate 44 in the visible wavelength region of polarized light that vibrates in the third direction, and more preferably 1.08 times or less.

Further, it is preferable that at least a part of the first polarizing plate 34 be configured by the reflective polarizing plate. Specifically, for example, it is preferable that the first polarizing plate 34 include the reflective polarizing plate 34a. In this case, light absorption in the first polarizing plate can be suppressed as compared with the case in which the entire first polarizing plate is configured by the absorption type polarizing plate. As a result, the efficiency of extracting light from the display device 1 can be further increased. From this viewpoint, it is also conceivable to configure the entire first polarizing plate 34 by the reflective polarizing plate. However, in a case in which the entire first polarizing plate 34 is configured by the reflective polarizing plate, the contrast of the display device 1 may decrease. Accordingly, it is snore preferable that the first polarizing plate 34 include the reflective polarizing plate 34a and the absorption type polarizing plate 34b.

Hereinafter, another example of preferable embodiments of the present disclosure will be described. In the following description, members that have functions substantially the same as those in the above embodiment will be referred to by common reference numerals, and the description thereof will be omitted.

### Second Embodiment

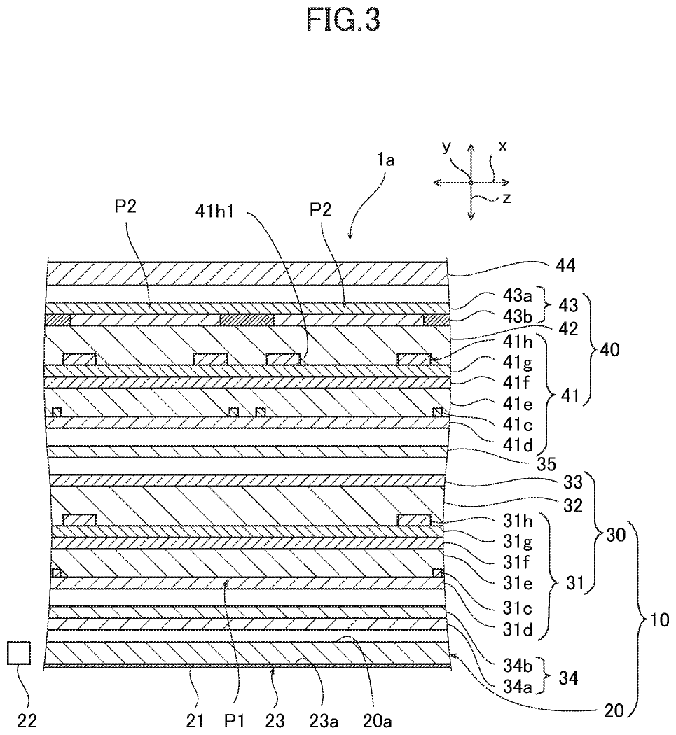

FIG. 3 is an enlarged schematic sectional view of a part of a display device la according to a second embodiment.

The display device 1a according to the second embodiment has configurations of the signal line and the reflection layer different from the display device 1 according to the first embodiment. The reflection layer is not provided in the display device 1a. The signal lines that include the first signal line 31b and the second signal line 31c are configured such that the average luminous reflectance of the surface of the signal lines that include the first signal line 31b and the second signal line 31c on the light source 20 side in the visible wavelength region is 70% or more. Therefore, the light emitted from the light source 20 is less likely to be absorbed by the signal lines that include the first signal line 31b and the second signal line 31c, and is reflected toward the light source 20 side with high reflectance. As a result, it is possible to improve the efficiency of extracting light from the display device 1a.

From the viewpoint of improving the efficiency of extracting light from the display device 1a, the signal lines that include the first signal line 31b and the second signal line 31c are preferably configured such that, the average luminous reflectance of the surface of the signal lines that include the first signal line 31b and the second signal line 31c on the light source 20 side in the visible wavelength region is 80% or more, and more preferably configured such that the average luminous reflectance is 85% or more.

As described above, the signal line that has a high average luminous reflectance of the surface on the light source 20 side in the visible wavelength region can be realized by, for example, the signal line in which at least surface layer on the light source 20 side is made of at least one of Al, Al alloy, Ag, Ag alloy, Pt, and Pt alloy. The entire signal lines may be made of at least one of Al, Al alloy, Ag, Ag alloy, Pt, and Pt alloy, or a part of the signal lines may be made of at least one of Al, Al alloy, Ag, Ag alloy, Pt, and Pt alloy. Specifically, in the present embodiment, the signal lines that include the first signal line 31b and the second signal line 31c are made of at least one of Al, Al alloy, Ag, Ag alloy, Pt, and Pt alloy, and include a first layer positioned on the surface layer on the light source 20 side, and a second layer that is formed on the first layer and is made of any of at least one metal selected from the group consisting of Ti, Cu, Mo, W, and Ta, an oxide including at least one metal of Ti, Cu, Mo, W, and Ta, and a nitride including at least one metal of Ti, Cu, Mo, W, and Ta.

### Third Embodiment

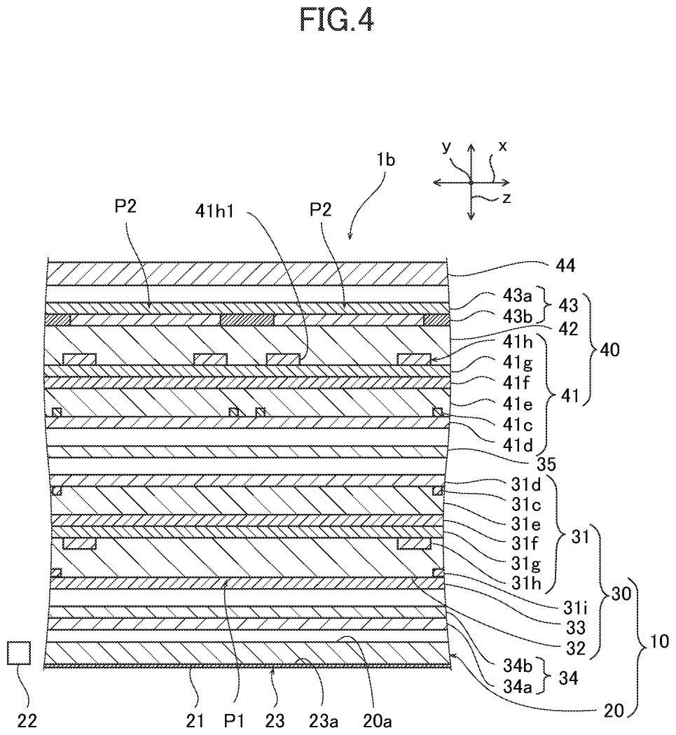

FIG. 4 is an enlarged schematic sectional view of a part of a display device 1b according to a third embodiment.

The display device 1b according to the third embodiment is different from the display device 1 according to the first embodiment in the positional relationship of the active matrix substrate 31 and the counter substrate 33 to the liquid crystal layer 32 and the position of the reflection layer 31i.

In the display device 1b, the active matrix substrate 31 is disposed on the side of the liquid crystal layer 32 opposite to the light source 20. The counter substrate 33 is disposed on the liquid crystal layer 32 on the light source 20 side. The reflection layer 31i is disposed on the counter substrate 33. Also in the present embodiment, the reflection layer 31i is disposed closer to the light source 20 than the signal lines that include the first signal line 31b and the second signal line 31c. The reflection layer 31i is disposed on at least a part of a region overlapping the signal line in plan view. The average luminous reflectance of the reflection layer 31i in the visible wavelength region is higher than the average luminous reflectance of the signal line in the visible wavelength region. Accordingly, also in the display device 1b according to the present embodiment, the efficiency of extracting the light emitted from the light source 20 can be improved as in the display device 1.

### Fourth Embodiment

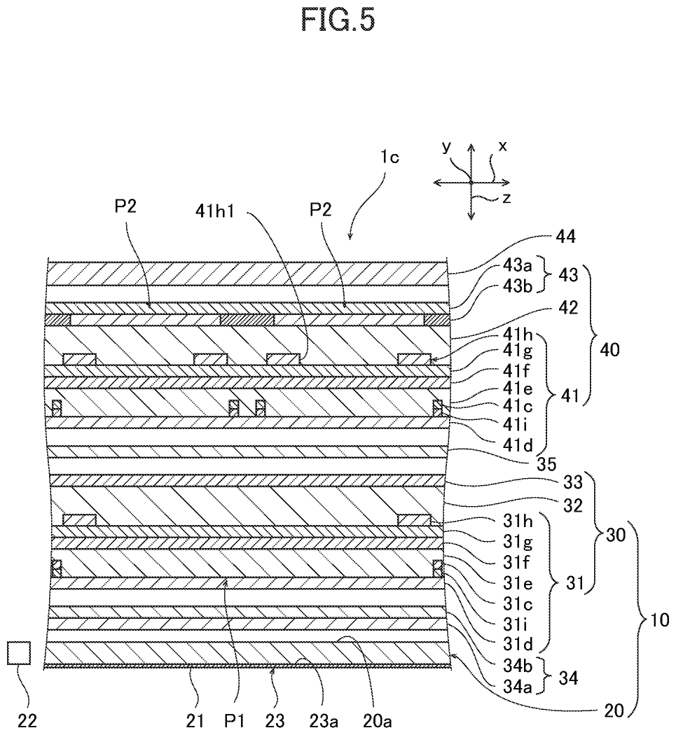

FIG. 5 is an enlarged schematic sectional view of a part of a display device 1c according to a fourth embodiment.

The display device 1c according to the fourth embodiment is different from the display device 1 according to the first embodiment in that a reflection layer 41i is formed in the liquid crystal panel 40 for display. The reflection layer 41i is disposed closer to the light source 20 than the signal lines (hereinafter, may be referred to as “another signal line”) that include the first signal line and the second signal line 41c of the liquid crystal panel 40 for display. The reflection layer 411 is disposed on at least a part of a region overlapping another signal line in plan view. The average luminous reflectance of the reflection layer 41i in the visible wavelength region is higher than the average luminous reflectance of another signal line in the visible wavelength region. Therefore, it is possible to suppress absorption by another signal line of the light emitted from the light source 20. As a result, in the display device 1c in which the reflection layer 41i is provided, it is possible to further improve the efficiency of extracting the light emitted from the light source 20.

From the viewpoint of improving the efficiency of extracting the light emitted from the light source 20, the average luminous reflectance of the reflection layer 41i in the visible wavelength region is preferably higher than the average luminous reflectance of another signal line in the visible wavelength region by 10% or more, and more preferably by 50% or more.

The configuration of the reflection layer 41i can be substantially the same as the configuration of the reflection layer 31i. Therefore, the description regarding the reflection layer 31i is incorporated into the reflection layer 41i.

In the present embodiment, an example has been described in which the active matrix substrate 31 is positioned closer to the light source 20 than the liquid crystal layer 32, and the counter substrate 33 is positioned on the side of the liquid crystal layer 32 opposite to the light source 20. However, the present disclosure is not limited to this configuration. Also in the present embodiment, for example, as in the display device 1b according to the third embodiment illustrated in FIG. 4, the liquid crystal panel 30 for dimming may be configured such that the active matrix substrate 31 is positioned on the side of the liquid crystal layer 32 opposite to the light source 20, and the counter substrate 33 is positioned closer to the light source 20 than the liquid crystal layer.

Further, in the present embodiment, an example has been described in which the liquid crystal panel 30 for dimming has the reflection layer 31i. However, the present disclosure is not limited to this configuration. Also in the present embodiment, for example, as in the display device 1a according to the second embodiment illustrated in FIG. 3, the reflection layer 31i may be not provided in the liquid crystal panel 30 for dimming, and the average luminous reflectance of the surface of the signal lines that include the first signal line 31b and the second signal line 31c on the light source 20 side in a visible wavelength region may be 70% or more.

### Fifth Embodiment

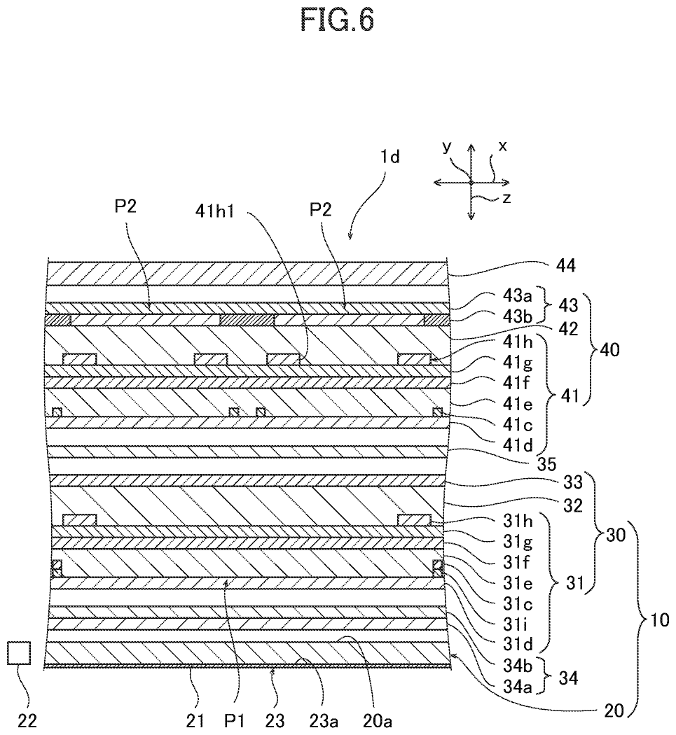

FIG. 6 is an enlarged schematic sectional view of a part of a display device 1d according to a fifth embodiment.

The display device 1d according to the fifth embodiment has configurations of the signal line and the reflection layer different from the display device 1c according to the fourth embodiment. Unlike the display device 1c, the reflection layer is not provided in the display device 1d. The signal lines (another signal line) that include the first signal line and the second signal line 41c of the liquid crystal panel 40 for display are configured such that the average luminous reflectance of the surface of the signal lines (another signal line) that include the first signal line and the second signal line 41c on the light source 20 side in the visible wavelength region is 85% or more. Therefore, the light emitted from the light source 20 is less likely to be absorbed by another signal line, and is reflected toward the light source 20 side with high reflectance. As a result, it is possible to improve the efficiency of extracting light from the display device 1d.

From the viewpoint of improving the efficiency of extracting light from the display device 1d, it is preferable that another signal line be configured such that the average luminous reflectance of the surface of another signal line on the light source 20 side in the visible wavelength region is 90% or more.

The configuration of another signal line can be substantially the same as the configuration of the signal lines that include the first signal line 31b and the second signal line described in the second embodiment. Therefore, the description regarding the signal lines that include the first signal line 31b and the second signal line 31c in the second embodiment is incorporated into another signal line.

In the present embodiment, an example has been described in which the active matrix substrate 31 is positioned closer to the light source 20 than the liquid crystal layer 32, and the counter substrate 33 is positioned on the side of the liquid crystal layer 32 opposite to the light source 20. However, the present disclosure is not limited to this configuration. Also in the present embodiment, for example, as in the display device 1b according to the third embodiment illustrated in FIG. 4, the liquid crystal panel 30 for dimming may be configured such that the active matrix substrate 31 is positioned on the side of the liquid crystal layer 32 opposite to the light source 20, and the counter substrate 33 is positioned closer to the light source 20 than the liquid crystal layer.

Further, in the present embodiment, an example has been described in which the liquid crystal panel 30 for dimming has the reflection layer 31i. However, the present disclosure is not limited to this configuration. Also in the present embodiment, for example, as in the display device 1a according to the second embodiment illustrated in FIG. 3, the reflection layer 31i may be not provided in the liquid crystal panel 30 for dimming, and the average luminous reflectance of the surface of the signal lines that include the first signal line 31b and the second signal line 31c on the light source 20 side in a visible wavelength region may be 70% or more.

### Sixth Embodiment

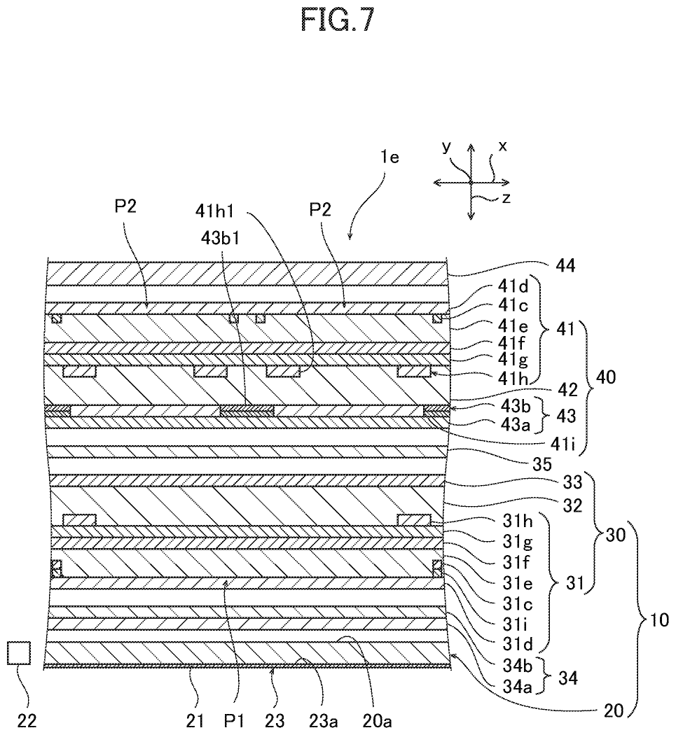

FIG. 7 is an enlarged schematic sectional view of a part of a display device 1e according to a sixth embodiment.

The display device 1e according to the sixth embodiment is different from the display device 1c according to the fourth embodiment in the positional relationship of the active matrix substrate 41 and the counter substrate 43 to the liquid crystal layer 42 and the position of the reflection layer 41i.

In the display device 1e, the active matrix substrate 41 is disposed on the side of the liquid crystal layer 42 opposite to the light source 20. The counter substrate 43 is disposed on the liquid crystal layer 42 on the light source 20 side. The reflection layer 41i is disposed on at least a part of a region overlapping another signal line in plan view. The average luminous reflectance of the reflection layer 41i in the visible wavelength region is higher than the average luminous reflectance of another signal line in the visible wavelength region. Accordingly, also in the display device 1e according to the present embodiment, the efficiency of extracting the light emitted from the light source 20 can be improved as in the display device 1c.

Specifically, in the present embodiment, the reflection layer 41i is disposed in the counter substrate 43. More specifically, the reflection layer 41i is disposed on the color filter substrate 43b. Still more specifically, the reflection layer 41i is disposed below a black matrix 43b1 of the color filter substrate 43b (on the light source 20 side). The reflection layer 41i is provided over the entire region in which the black matrix 43b1 is provided. Therefore, in the display device 1e, it is possible to suitably reflect the light incident on the black matrix 43b1 that does not substantially transmit light by the reflection layer 41i toward the light source 20 side. As a result, in the display device 1e, it is possible to improve the efficiency of extracting the light emitted from the light source 20.

In the present embodiment, an example has been described in which the active matrix substrate 31 is positioned closer to the light source 20 than the liquid crystal layer 32, and the counter substrate 33 is positioned on the side of the liquid crystal layer 32 opposite to the light source 20. However, the present disclosure is not limited to this configuration. Also in the present embodiment, for example, as in the display device 1b according to the third embodiment illustrated in FIG. 4, the liquid crystal panel 30 for dimming may be configured such that the active matrix substrate 31 is positioned on the side of the liquid crystal layer 32 opposite to the light source 20, and the counter substrate 33 is positioned closer to the light source 20 than the liquid crystal layer.

Further, in the present embodiment, an example has been described in which the liquid crystal panel 30 for dimming has the reflection layer 31i. However, the present disclosure is not limited to this configuration. Also in the present embodiment, for example, as in the display device 1a according to the second embodiment illustrated in FIG. 3, the reflection layer 31i may be not provided in the liquid crystal panel 30 for dimming, and the average luminous reflectance of the surface of the signal lines that include the first, signal line 31b and the second signal line 31c on the light source 20 side in a visible wavelength region may be 70% or more.

The present disclosure contains subject matter related to that disclosed in Japanese Priority Patent Application JP 2020-044112 filed in the Japan Patent Office on Mar. 13, 2020, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
an illumination device that emits light; and
a liquid crystal panel for display that displays an image by controlling transmission of the light emitted from the illumination device,
wherein the illumination device includes
a light source, and
a liquid crystal panel for dimming which is disposed closer to the liquid crystal panel for display than the light source, and
the liquid crystal panel for dimming includes
a signal line, and
a reflection layer that is disposed closer to the light source than the signal line in at least a part of a region overlapping the signal line in plan view, and has a higher average luminous reflectance in a visible wavelength region of 400 nm or more and 700 nm or less than the signal line.

2. The display device according to claim 1, wherein the reflection layer includes a layer made of at least one metal of Al, Ag, and Pt.

3. The display device according to claim 1, wherein the reflection layer includes a dielectric multilayer film in which a low-refractive-index dielectric film that has a relatively low refractive index and a high-refractive-index dielectric film that has a relatively high refractive index are alternately laminated.

4. The display device according to claim 1,
wherein the liquid crystal panel for dimming further includes a liquid crystal layer, and
the reflection layer is disposed closer to the light source than the liquid crystal layer.

5. The display device according to claim 1, wherein a surface layer of the signal line on a side of the light source is made of any of at least one metal selected from the group consisting of Ti, Cu, Mo, W, and Ta, an oxide including at least one metal of Ti, Cu, Mo, W, and Ta, and a nitride including at least one metal of Ti, Cu, Mo, W, and Ta.

6. A display device comprising:
an illumination device that emits light; and
a liquid crystal panel for display that displays an image by controlling transmission of the light emitted from the illumination device,
wherein the illumination device includes
a light source, and
a liquid crystal panel for dimming which is disposed closer to the liquid crystal panel for display than the light source,
the liquid crystal panel for dimming includes a signal line, and
the signal line is configured such that an average luminous reflectance of a surface of the signal line on a side of the light source in a visible wavelength region of 400 nm or more and 700 nm or less is 70% or more.

7. The display device according to claim 6, wherein at least a surface layer of the signal line on the side of the light source is made of at least one metal of Al, Ag, and Pt.

8. The display device according to claim 1, further comprising:
a first polarizing layer that is disposed closer to the light source than the liquid crystal panel for dimming; and
a second polarizing layer that is disposed closer to the liquid crystal panel for display than the liquid crystal panel for dimming,
wherein an average transmittance of the first polarizing layer in a visible wavelength region of polarized light that vibrates in a first direction parallel to a transmission axis of the first polarizing layer is higher than an average transmittance of the second polarizing layer in a visible wavelength region of polarized light that vibrates in a second direction parallel to a transmission axis of the second polarizing layer.

9. The display device according to claim 8, wherein the first direction and the second direction are orthogonal to each other.

10. The display device according to claim 8, further comprising a third polarizing layer that is disposed on a side of the liquid crystal panel for display opposite to the light source,
wherein the average transmittance of the first polarizing layer in the visible wavelength region of polarized light that vibrates in the first direction is higher than an average transmittance of the third polarizing layer in a visible wavelength region of polarized light that vibrates in a third direction parallel to a transmission axis of the third polarizing layer.

11. The display device according to claim 6, wherein the signal line includes a layer made of any of at least one metal selected from the group consisting of Ti, Cu, Mo, W, and Ta, an oxide including at least one metal of Ti, Cu, Mo, W, and Ta, and a nitride including at least one metal of Ti, Cu, Mo, W, and Ta.

12. The display device according to claim 1, wherein the liquid crystal panel for display includes
an other signal line, and
an other reflection layer that is disposed closer to the light source than the other signal line in at least a part of a region overlapping the other signal line in plan view, and has a higher average luminous reflectance in the visible wavelength region than the other signal line.

13. The display device according to claim 1,
wherein the liquid crystal panel for display includes an other signal line, and
the other signal line is configured such that an average luminous reflectance of a surface of the other signal line on a side of the light source in the visible wavelength region is 85% or more.

14. The display device according to claim 1, wherein the light source includes
a light emitting element, and
a reflective surface that reflects light emitted from the light emitting element toward the liquid crystal panel for display.
